(19) United States
(12) Patent Application Publication
(10) Pub. No.: US 2012/0041619 A1
(43) Pub. Date: Feb. 16, 2012

(54) System for Aircraft

(76) Inventors: Grenfell Saxon Rudduck, South Australia (AU); Dickory Rudduck, Chicago, IL (US); Christopher Kelliher, Chicago, IL (US)

(21) Appl. No.: 13/060,516

(22) PCT Filed: Aug. 25, 2009
(86) PCT No.: PCT/US09/54961

§ 371 Date: May 10, 2011

Related U.S. Application Data
(60) Provisional application No. 61/091,444, filed on Aug. 25, 2008.

(51) Int. Cl. G01M 17/00

(52) U.S. Cl. 701/3

(57) ABSTRACT

This invention relates to a sensing system with networking capabilities that is integrated into an aircraft that allows for rapid reconfiguration, monitoring, and access control of the aircraft by way of using fastening mechanisms, namely those with intelligent capabilities that provide sensing, control, and monitoring capabilities.

### FIELD OF THE INVENTION

This invention relates a system of control, sensing, and fastening of aircraft functions. More specifically this invention relates to a system integrated into an airplane that allows for rapid reconfiguration of an aircraft by way of using fastening mechanisms, namely those with intelligent capabilities that provide sensing, control, and monitoring capabilities.

### BACKGROUND OF THE INVENTION

There is a marked trend in the airline industry towards improving both passenger and crew comfort, safety, and security while maintaining airline profitability. It is difficult for an airline to maintain profitability while balancing passenger and crew demands of comfort and government safety and security regulations while trying to keep fares at the lowest possible level to meet existing demand and encourage air travel.

In today's airline industry, there is also the trend of leasing arrangements for airplanes. First, in cases of new airline companies, purchasing aircraft can be a large, expensive commitment and the idea of testing the industry with leased airplanes is a way to get into the business without assuming a large amount of risk. Second, there are backlogs on the production of new airplanes. Both new and existing airline companies may have a demand for aircraft that cannot be met by the suppliers. Leasing airplanes is a way to meet a demand quickly without having to wait out a long backlog. Because airplanes are commonly leased, it is important that the airplanes can be easily customized to meet the lessee's demands. Airplane lessor's do not want to spend a lot of time or money to reconfigure an aircraft for a particular lessee. Further, once an aircraft is leased, the lessee may have a wide variety of uses for the airplane and may need to reconfigure the aircraft easily and in a way that they can easily monitor aircraft function.

The present invention in some of its aspects is intended to take advantage of these trends by proving a system that can assist the in normal crew duties, extend the crew's capabilities and possibly reduce crew numbers, control and monitor flight service items, monitor galley health, indicate and order scheduled maintenance of the aircraft or its galley, allow for rapid reconfiguration, and monitor payload.

### SUMMARY OF THE INVENTION

This invention relates to a system that is able to collect, record, process, and distribute data from sensors and/or fasteners incorporated with sensing capabilities. The sensors and/or fasteners are affixed on an infinite number of items within the aircraft so that data such as weight, temperature, moisture, access, maintenance, etc. can be monitored. One skilled in the art will recognize that any item within an aircraft that requires monitoring, service, or general oversight will benefit from being a part of the system. This system will assist flight crew and ground maintenance personnel with many daily/periodic tasks and also will control and monitor the operation of the varying items employing this invention.

The invention utilizes a wide range of fasteners, fastening systems, fastener assemblies, sensors and related areas thoroughly discussed in International Application No. PCT/AU2004/001580 and incorporated herein by reference. In aspects of the fasteners discussed, reference is made to material adapted to contract when activated. The material adapted to contract when activated is preferably shape memory alloy wire. Shape memory alloys are known and are usually made predominantly or wholly of titanium and nickel. They may also include other material, such as aluminium, zinc and copper. A shape memory alloy is capable of adopting one shape below a predetermined transition temperature and changing to a second shape once its temperature exceeds the transition temperature. Conversely, when the shape memory alloy cools below the transition temperature, it is capable of adopting the first shape again. In connection with the various aspects of the present invention, the shape memory alloy contracts when heated in situ. Shape memory alloy wire currently available, such as that sold under the trade mark Nitinol, is capable of contracting by about 3% when activated by heating.

Activation of the material adapted to contract when activated is preferably achieved through electrical resistance heating, with a wire feed to the assembly. Activation of the shape memory alloy wire can be initiated from a central location, using the wiring system of, for example, an air craft or automobile. It is also within the scope of this invention that the activation is initiated by remote means, such as a hand held tool operating through the use of any suitable form of energy, including microwave, electric magnetic, sonic, infra-red, radio frequency and so on.

The scope of the invention in its various aspects is not necessarily limited to the use of shape memory alloy. Other material may also be useful. Also, while activation may take place through heating, other means of activation may be suitable and are within the scope of this invention.

The fasteners of this invention are preferably envisioned to be “intelligent” in nature, be addressable, include sensors, and interface with a network. The fasteners on an aircraft may all be part of one network or may be divided into networks dedicated to one area of the aircraft. For simplicity of describing this invention, it is understood that it will be described as all being part of one network that can operate within the aircraft or directly to human interfaces, such as display panels.

One area that is of particular importance to a flight crew is the galley area. Every airline depending on the type of service it provides may have varying galley needs. Some airlines may require additional service item (food/drink) storage, others may require additional storage compartments for passenger luggage, some require storage of medical equipment or crew rest areas, etc. One skilled in the art will recognize that galley needs are not limited to the scenarios described above. In many current flight situations, the crew must make do with the standard galley arrangement regardless of the flights needs. This results in a struggle to stow carry-on luggage, manage flight service items, stow trash as it is collected, secure medical equipment, etc. while working within industry safety and security regulations and assisting the airline in making a profitable flight. This system would allow an airline or aircraft leasing company the ability to easily customize an aircraft to meets current demands of customers in a more profitable manner.

Aircraft utilizing this invention will comprise of storage bins, service dispensers, seats, doors, panels, window shades, etc. coupled with the intelligent fasteners to initially allow for configuration. All parts of the interior of the aircraft are modular in nature to allow for reconfiguration. Storage bins, as an example, will be affixed to the structure of the aircraft and to each other by way of an intelligent fastener. Because the fasteners utilized allow of easy locking and release storage bins can be arranged in any number of suitable arrangements. Once a storage bin is in place, it can provide a wide variety of data to a flight crew. The sensing capability within a fastener can sense whether of not the bin is locked, what the weight of the items within the bins are, if there is undesired moisture, temperatures, or gasses within a bin, or if the bin is operating properly. One skilled in the art will recognize that these are not the only functions the sensors can perform. Once the data is collected, the system will process the data and distribute it to aircraft personnel for oversight and instruction. If errors are detected, the flight crew can easily pinpoint the problem area and quickly work to resolve any issues.

On an aircraft, weight or payload monitoring is of particular concern for a variety of reasons. Each aircraft is designed to only hold a certain amount of weight to fly safely and airliners are required to abide by the regulations governing weight. However, the more weight an airplane can hold, the more profitable the flight will be because additional passengers and freight can be added to the flight. Airlines currently have accurate weight counts for the aircraft itself, fuel, and checked luggage typically in the underbelly but only estimates the weight of passengers and carry-on luggage. Fasteners affixed to seats in addition to storage bins could provide an accurate weight measurement to an airline for further analysis. It is also envisioned that sensors for weight could be placed on an entry mat for weight management. Once the data was collected, it will be processed by the system and given to the flight crew to determine if there are additional safety and/or security measures that must be taken or if there is room for additional freight in the aircraft underbelly resulting in additional profits for a flight.

Fasteners affixed to seats also allow for easy reconfiguration of the seats depending on flight needs. Certain flights may require more first class and/or business class travel arrangements or room for stretchers for ill or infirm passengers. The fasteners allow an aircraft to easily unlock and move a seat into a desired location while maintaining safety precautions. If a seat is broken or requires maintenance, scheduled or otherwise, the sensors could collect data and report to the system necessary tasks. This would save flight crew and ground personnel a considerable amount of time that would be taken up by troubleshooting a problem.

Rapid reconfiguration of the seats or the galley could also result in rest areas for the crew of luxury rest areas for passengers on a long flight. Airlines could reconfigure areas to include sleeping bucks which would attract higher paying customers desiring a luxury arrangement. Alternatively these bunks can be used for crew rest areas providing increased operational flexibility for the airline.

Doors and other securing panels are of a concern to airlines for varying safety and security reasons. Cockpit doors must be securely locked during flights for general flight security, flight service carts must be secured when not in use for safety reasons, panels housing oxygen masks must be secured and facilitate easy safety inspections, and all other panels/doors for enclosing items such as restroom or emergency equipment doors are of particular importance to airline. Utilizing this system, doors and panels are to be equipped with an intelligent fastener linked to the network for monitoring by the system. Data indicating problems or other information such as occupancy of toilets during some stages of flight will then be relayed to flight crews.

The galley houses flight service items, such as food, drinks and other items for passenger comfort and enjoyment of the flight. Flight crews face the challenge of checking service items in pre-boarding for quality, short supply, unauthorized items being smuggled on board and then face the challenge of heating food items before service. In order to conserve flight staff's time pre-boarding, catering carts may be equipped with sensors compatible with the system to provide feedback such as food and beverage count, dates and temperature throughout the flight for food health safety reasons. Or in order to manage flight service items and to free up crew service time, a galley may be outfitted with vending capabilities or self service bars as an example.

Sensors within the aircraft can also provide feedback on galley health and overall status such as temperature, moisture levels, cabin air quality, etc.

This system is separate from other systems/networks on an aircraft. All wiring, data transmission means, and electronic capabilities are to be completely independent from the aircraft so that there would be no interference with the aircraft. This system is designed to enhance aircraft capabilities by allowing for an infinite number of configuration, increase aircraft profitability by lessening the time crews spend on problems or analyzing situations and extending flight crew capabilities.

All fasteners may be equipped with a manual release in cases where power is lost or other malfunction.

Other advantages and aspects of the present invention will become apparent upon reading the following description of the drawings and the detailed description of a preferred embodiment of the invention.

### BRIEF DESCRIPTION OF THE DRAWINGS

FIG. 1 depicts a detailed view of the aircraft and an arrangement possibility.

FIG. 2 is a cross-sectional view of the aircraft with detail of the wiring arrangement.

FIG. 3 is a sectional view of the aircraft seat tracks.

FIG. 4 depicts the modularity of storage bins, seats, and flight service item storage that may be contained in a galley.

FIGS. 5-8 depict possible modular arrangements for the galley.

FIG. 9 is a cross-sectional view of a modular arrangement highlighting medical unit.

FIG. 10 is a plan view of a modular arrangement highlighting a medical unit.

FIG. 11 is a cross-sectional view of a modular arrangement highlighting crew rest areas in the galley.

FIG. 12 is a plan view of a modular arrangement highlighting crew rest areas in the galley.

FIG. 13 is a cross-sectional view of a modular arrangement highlighting vending arrangements in the galley.

FIG. 14 is a plan view of a modular arrangement highlighting vending arrangements in the galley.

FIG. 15 is a cross-sectional view of a modular arrangement highlighting additional seating in the galley.

FIG. 16 is a plan view of a modular arrangement highlighting additional seating in the galley.

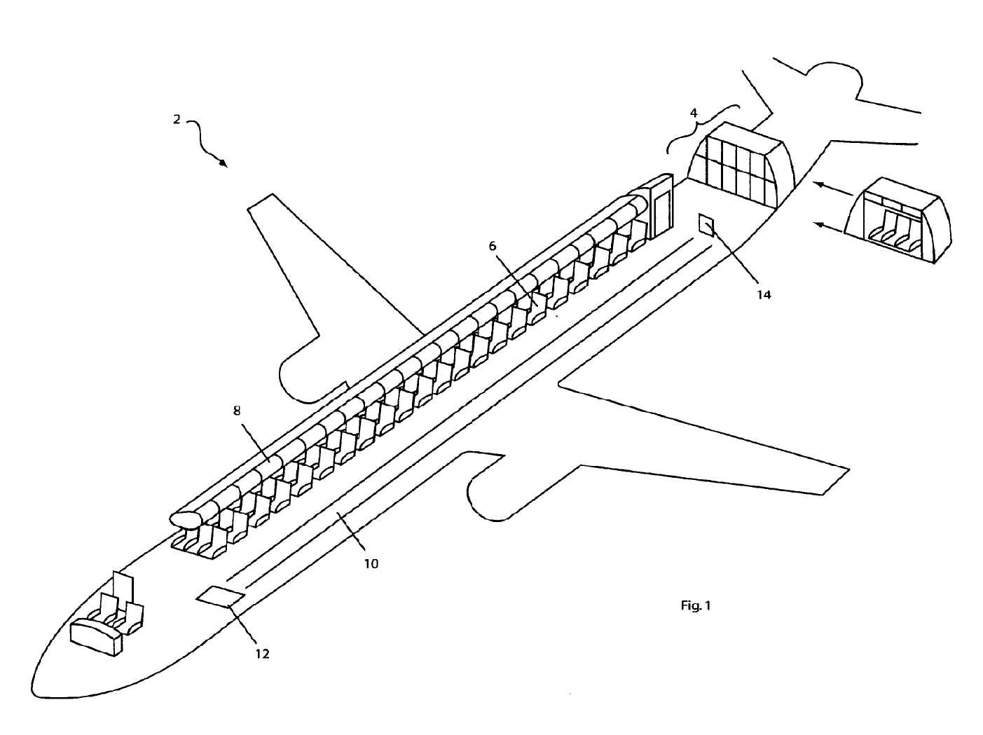

### DETAILED DESCRIPTION OF THE PREFERRED EMBODIMENT

Turning to the figures, FIG. 2 embodies a view of the aircraft 2 depicting the arrangement of the preferred wiring and data transmission means 18. Seats 6 are affixed to a seat track 10 by way of an intelligent fastener 16 connected to the wiring and data transmission means 18. Further, personal service items 20, such as oxygen masks, are connected to the data transmission means 20 of the system by way of a fastener 16.

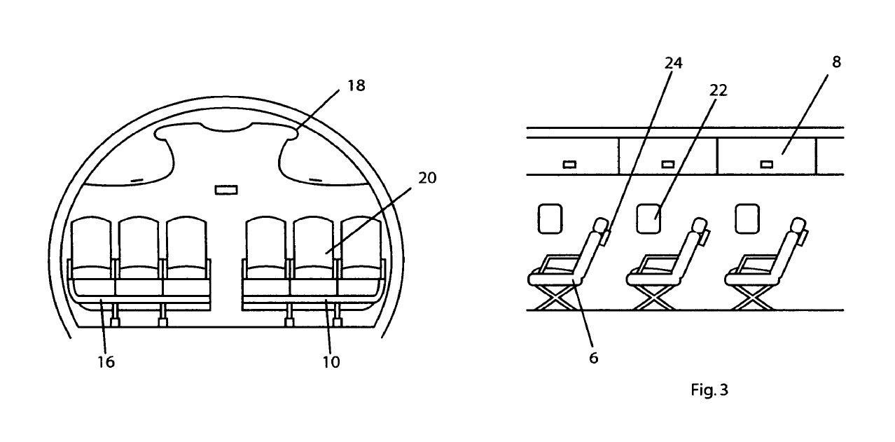

FIG. 3 depicts an arrangement of the system similar to FIG. 2 except that storage bins 8 and window shades 22 are seen. Both are capable of being connected to the data transmission means 18 by way of fasteners 16.

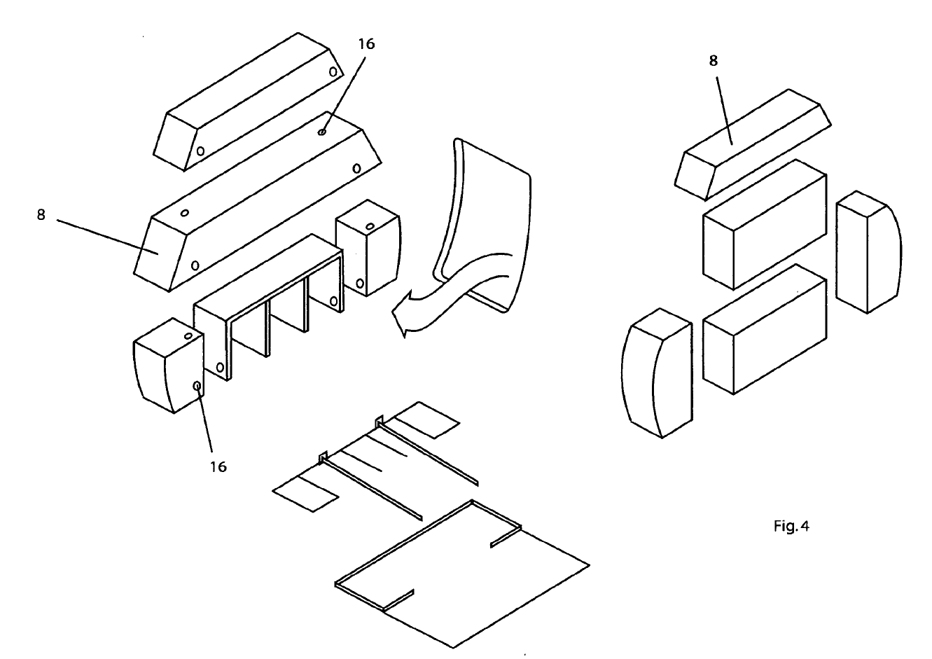

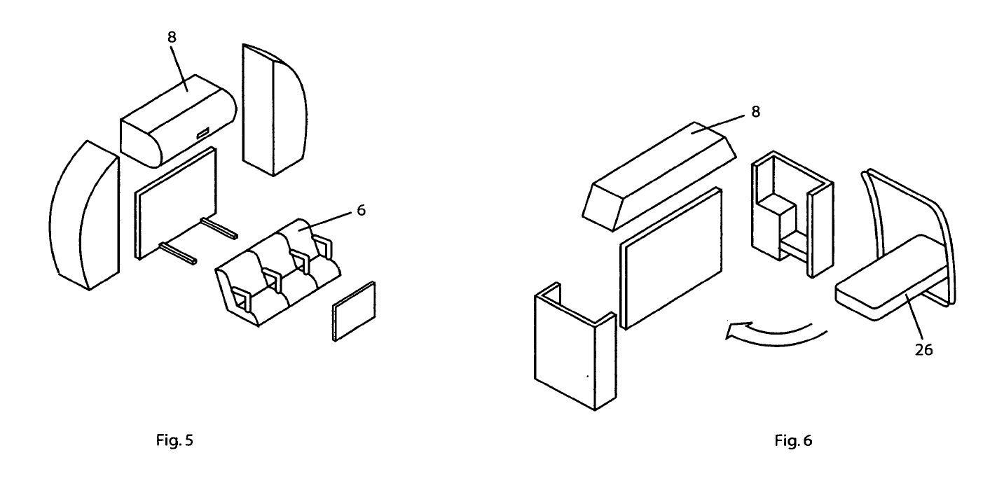

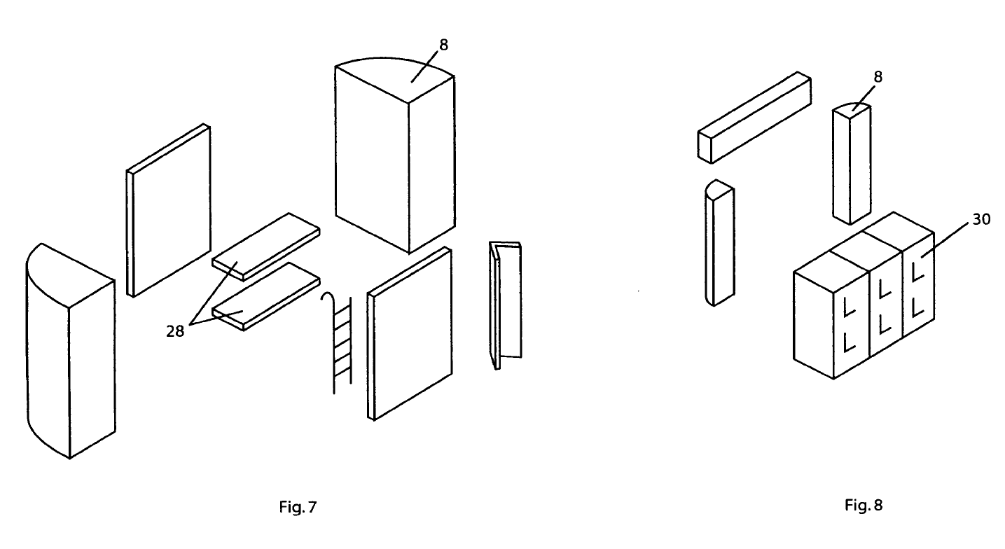

Modular arrangements of storage bins 8 are preferred in this invention as seen in FIG. 4. Each storage bin is equipped with a fastener 6 or a series of fasteners 6 that serve to lock the storage bins 8 together or to the interior of the aircraft 2.

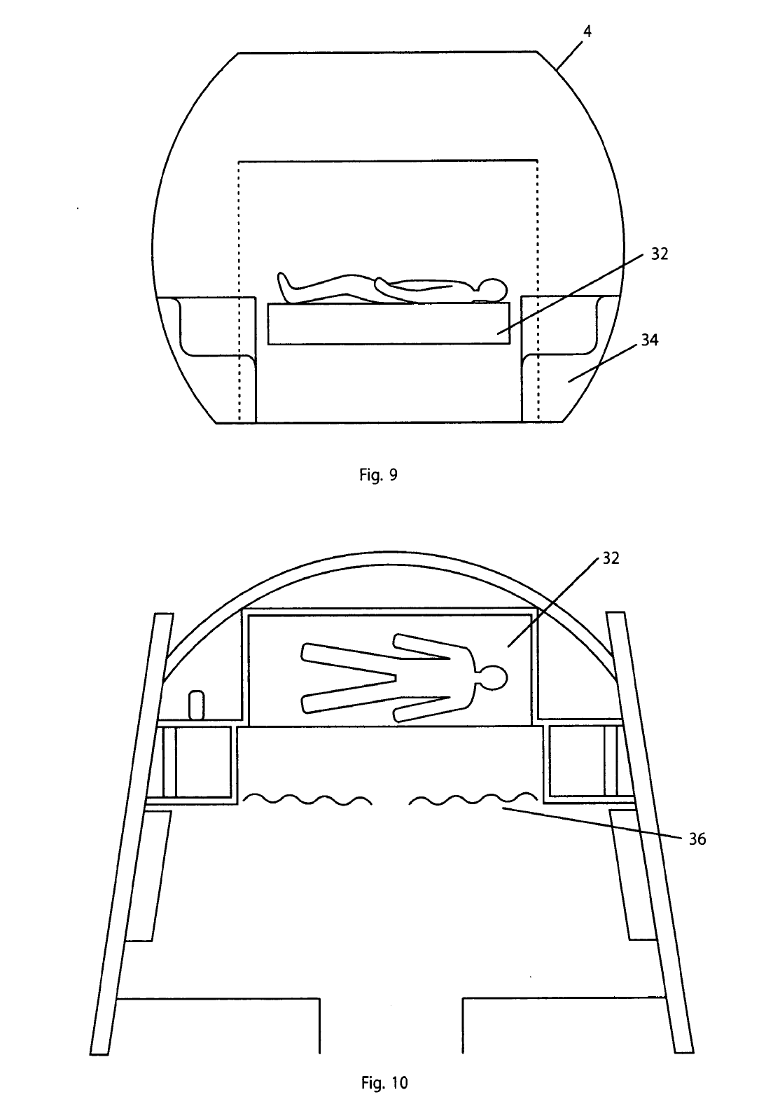

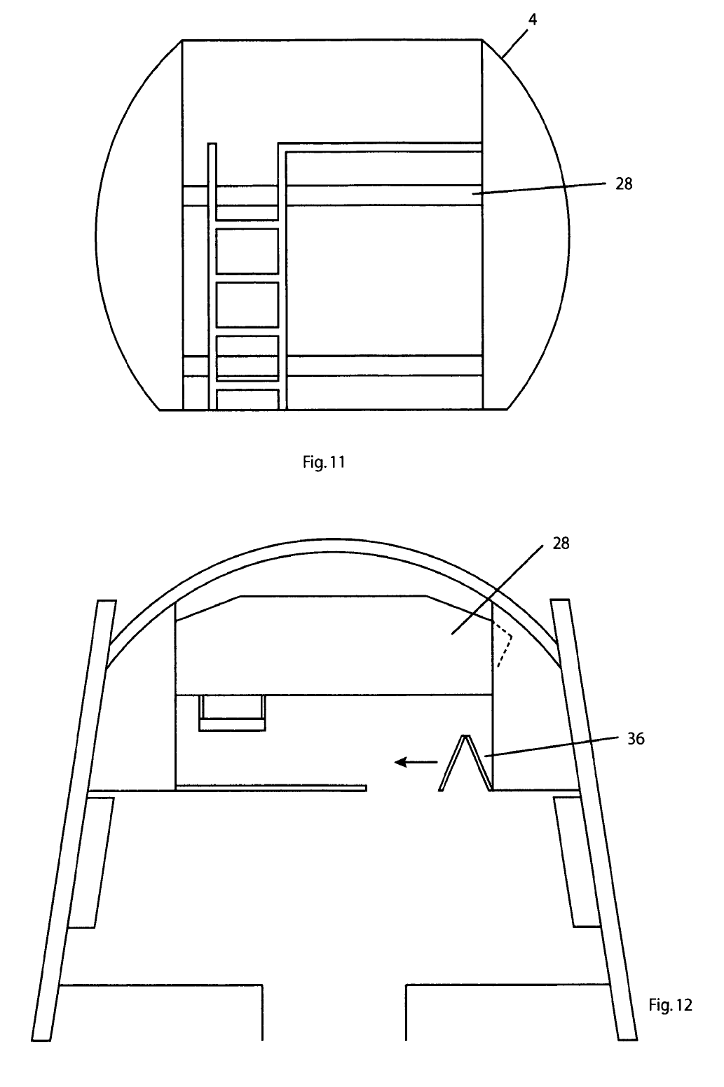

In situations of galley 4 reconfiguration, such as the medical arrangement see in FIGS. 9 and 10 or crew/passenger rest areas of FIGS. 11 and 12, the traditional galley 4 is replaced with a stretcher 32 or bunks 28, a privacy curtain 36, and medical equipment storage 34. All items can be monitored by the fasteners 6 affixing them to the aircraft 2 and to each other. Additionally, more customized arrangements can be easily achieved by the systems ability to be rapidly reconfigured.

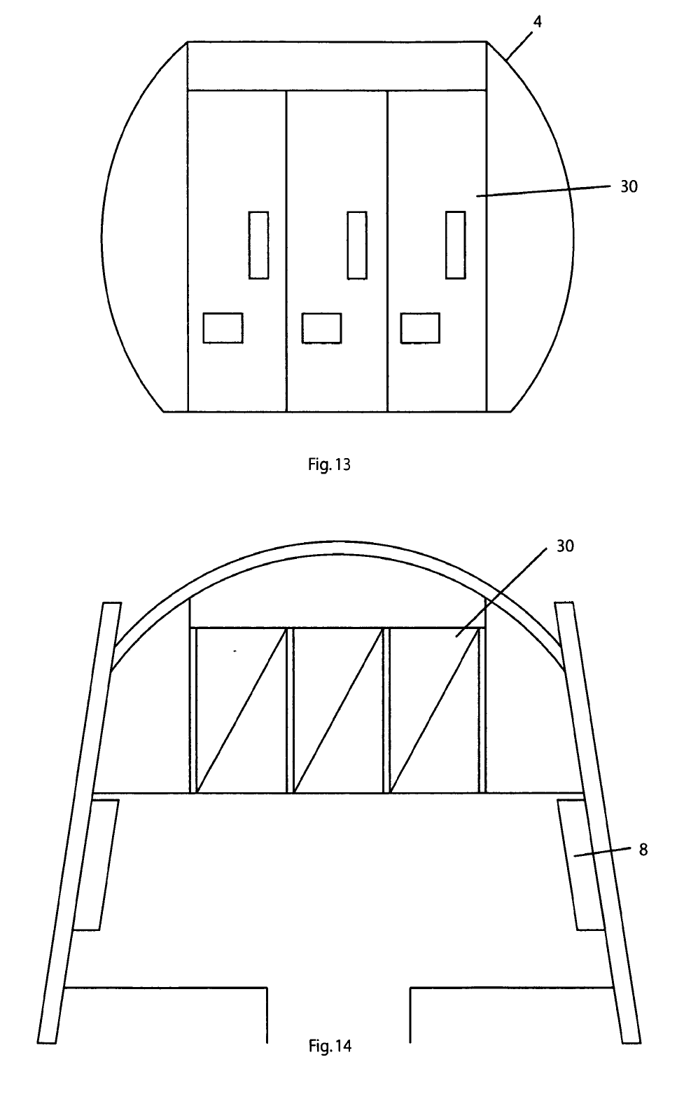

In situations requiring that the galley 4 be configured to house flight service items in an organized and more efficient manner for the flight crew, vending machines 30 such as those seen in FIGS. 13 and 14.

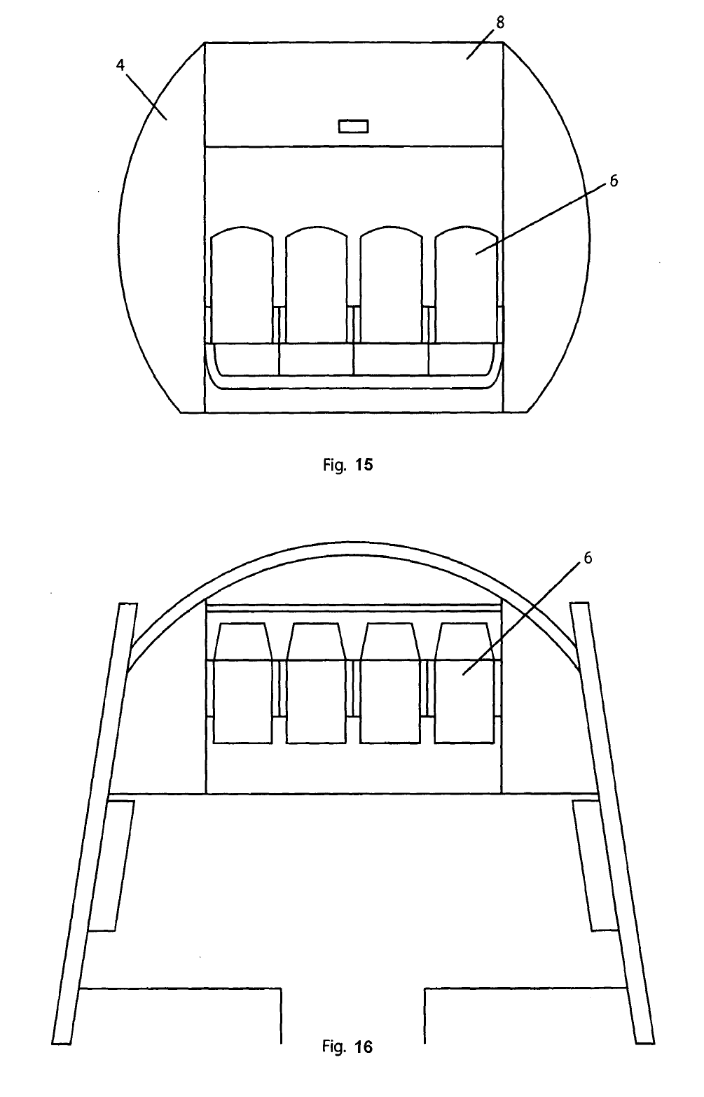

Galleys 4, like the passenger cabin can be reconfigured to hold more seating, such as the arrangement see in FIGS. 15 and 16. Seats 6 can be arranged along the galley 4 wall so that more passengers can take the flight easing aircraft overflow problems.

The invention may be described in terms of claims that can assist the skilled reader in understanding the various aspects and preferments of the invention. It will be appreciated by those skilled in the art that many modifications and variations may be made to the embodiments described herein without departing from the spirit and scope of the invention.

### Industrial Applicability

As will be appreciated by those skilled in the various arts, this invention disclosed herein is not limited to the examples set our above and has wide application in many areas. This invention represents a significant advance in the art of aircraft monitoring, sensing, and access control.

What is claimed is:

1. An aircraft sensing system comprising:
At least one intelligent fastener incorporated with sensing capabilities affixed onto an item that is capable of being monitored, serviced or having the ability be re-configured or to have controlled access.

2. The aircraft sensing system as in claim 1 wherein said at least one fastener is a plurality of fasteners, each of which comprise material adapted to contract when activated.

3. The aircraft sensing system as in claim 1 wherein said at least one fastener comprises sensors and the ability to interface with at least one network.

4. The aircraft sensing system of claim 3, wherein said sensors collect data such as weight, temperature, moisture, air quality, access, locked/unlocked status, or maintenance.

5. The aircraft sensing system as in claim 3 wherein said at least one network is a plurality of networks each of which are separated and can be dedicated to certain areas of the aircraft.

6. The aircraft sensing system of claim 4 wherein said sensors input data by way of data transmission means into said network that operates directly with human interfaces.

7. The aircraft sensing system of claim 5, wherein said human interface is a display panel, computer, or a PDA device.

8. An aircraft sensing system comprising:
at least one intelligent sensor affixed onto an item that is capable of being monitored, serviced or having the ability to be re-configured or to have controlled access.

9. The aircraft sensing system of claim 8 where said at least one sensor is a plurality of sensors.

10. The aircraft sensing system as in claim 9 wherein said plurality of sensors has the ability to interface with at least one network.

11. The aircraft sensing system of claim 8, wherein said sensors collect data such as weight, temperature, moisture, air quality, access, or maintenance.

12. The aircraft sensing system as in claim 10 wherein said at least one network is a plurality of networks each of which are separated and can be dedicated to certain areas of the aircraft.

13. The aircraft sensing system of claim 10 wherein said sensors input data into said network that operates directly with human interfaces.

14. The aircraft sensing system of claim 13, wherein said human interface is a display panel, computer, or a PDA device.
